(19) United States
(12) Patent Application Publication
(10) Pub. No.: US 2010/0099020 A1
(43) Pub. Date: Apr. 22, 2010

(54) ELECTROCHEMICAL ENERGY SOURCE AND ELECTRONIC DEVICE PROVIDED WITH SUCH AN ELECTROCHEMICAL ENERGY SOURCE

(75) Inventors: Martin Ouwerkerk, Eindhoven (NL); Rogier Adrianus Henrica Niessen, Eindhoven (NL); Petrus Henricus Laurentius Notten, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/529,363

(22) PCT Filed: Feb. 27, 2008
(86) PCT No.: PCT/IB08/50699

§ 371 Date: Sep. 1, 2009

(30) Foreign Application Priority Data
Mar. 5, 2007 (EP) 07103480.5

(51) Int. Cl. H01M 6/40; H01M 4/38; H01M 2/20

(52) U.S. Cl. 429/124; 429/220; 429/223; 429/231.5; 429/209

(57) ABSTRACT

Solid-state batteries, efficiently convert chemical energy into electrical energy and can be used as the power sources for portable-electronics. The invention relates to an improved electrochemical energy source. The invention also relates to an electronic device provided with such an electrochemical energy source. The energy source comprises at least two cells interconnected by means of at least one flexible element. This flexible element may comprise a conductive polymer or a conductive rubber. The electrodes may be provided with cavities (pillars, trenches, slits or holes). A barrier layer may be deposited between the electrodes and their substrate. The energy sources may be used in a “System in Package”.

### FIELD OF THE INVENTION

The invention relates to an improved electrochemical energy source. The invention also relates to an electronic device provided with such an electrochemical energy source.

### BACKGROUND OF THE INVENTION

Electrochemical energy sources based on solid-state electrolytes are known in the art. These (planar) energy sources, or ‘solid-state batteries’, efficiently convert chemical energy into electrical energy and can be used as the power sources for portable electronics. At small scale such batteries can be used to supply electrical energy to e.g. microelectronic modules, more particular to integrated circuits (IC's). An example hereof is disclosed in the international patent application WO 00/25378, where a solid-state thin-film micro battery is fabricated directly onto a specific substrate. During this fabrication process the first electrode, the intermediate solid-state electrolyte, and the second electrode are subsequently deposited as a stack onto the substrate. The substrate may be flat or curved to realise a two-dimensional or three-dimensional battery stack. A major drawback of the known batteries is that the batteries are substantially rigid, which limits the applicability of the known batteries considerably. There is however a growing need for stretchable and flexible power sources to power not only rigid electronic devices, such as implantable devices and domestic appliances, but also flexible electronic devices, such as textile electronics, in an efficient manner.

It is an object of the invention to provide a relatively flexible electrochemical energy source.

### SUMMARY OF THE INVENTION

This object can be achieved by providing an electrochemical energy source according to the preamble, comprising: multiple electrochemical cells, wherein each cell is deposited onto a substrate, each cell comprising a first electrode, a second electrode, and an electrolyte separating said first electrode and said second electrode; wherein at least two cells are interconnected by means of at least one flexible element. The flexible element is considered as a flexible interconnecting element or bridge to mutually connect multiple cells. Since the electrochemical energy source is in fact segmented into an array of substantially rigid cells mutually coupled by means of one or multiple flexible elements, all segments (formed by the cells) are able to move and shift independently from each other, thus resulting in a stretchable and relatively flexible energy source. Hence, by interconnecting multiple (substantially rigid) electrochemical cells by means of one or multiple flexible elements, a flexible assembly of cells can be obtained, which can advantageously be applied in a wide variety of applications. Fields of application for these stretchable batteries are applications in which a high degree of pliability of the application (and thus also the power source) is required. Applications meeting these requirements are, for example, textile electronics, washable electronics, applications requiring pre-shaped batteries, e-paper and a host of portable electronic applications.

It is noted that the first electrode commonly comprises an anode, and the second electrode comprises a cathode. Each electrode commonly also comprises a current collector. By means of the current collectors the cell can easily be connected to an electronic device. Preferably, the current collectors are made of at least one of the following materials: Al, Ni, Pt, Au, Ag, Cu, Ta, Ti, TaN, and TiN. Other kinds of current collectors, such as, preferably doped, semiconductor materials such as e.g. Si, GaAs, InP may also be applied.

In a preferred embodiment each cell is connected to at least one other cell by means of at least one flexible element. In this manner the electrochemical energy source can be formed by a single, flexible assembly. The cells may be arranged in a (linear or non-linear) line, thus in a one-dimensional manner. However, it is also conceivable for a person skilled in the art that the cells are oriented two-dimensionally, e.g. according to a matrix. Moreover, it is imaginable that the cells together are oriented according to a three-dimensional structure. It is therefore often preferably that one or multiple cells are simultaneously connected to multiple other cells by means of at least one flexible element.

Each flexible element may have a passive character, which means that the flexible element merely be adapted to mutually connect two (or more) electrochemical cells. However, it is preferred that at least one flexible element is provided an additional functionality, in particular a position-selective conducting functionality. To this end, at least one flexible element comprises at least one flexible conductor for connecting respective electrodes of adjacent cells. More preferably, each flexible element comprises multiple flexible conductors for connecting respective electrodes of adjacent cells. In this manner the anodes of all cells can be interconnected in a relatively efficient manner. The same applies for the cathodes of all cells. The conductors may be embedded within the flexible elements. Other parts of the interconnection are preferably made of an electrically insulating material to prevent shot-circuiting of the anode(s) and the cathode(s). The conductors are preferably made of a flexible material to secure the flexible characteristics of the interconnections. In a particular preferred embodiment at least one flexible conductor comprises a conductive polymer or a conductive rubber. Nowadays a wide range of possible conductive polymers and rubbers are available which can be suitably used for interconnecting battery segments. Premix Thermoplastics, for example, manufactures electrically conductive thermoplastics compounds with ‘controlled resistance’ levels. These materials, consisting of conductive nylons or conductive polyester urethanes, can be manufactured with virtually any resistivity ranging from 1 Ohm-cm to 1·10⁻¹¹ Ohm-cm. Conductive rubbers are, for example, manufactured by NanoSonic®. These materials are effectively nanocomposites, which effectively combine the matrix and filler in a way that preserves the mechanical properties of the matrix, while also utilizing the conductive properties of the filler. The result is a nanocomposite containing a suitable amount of metal in an elastomeric polymer backbone, which enables it to stretch up to 300 percent its size and then recover its original shape and conductivity. It may be clear that also other materials may be used to act as flexible conductor. Eventual insulating parts of the interconnections are preferably made of an insulating polymer or an insulating rubber.

In an alternative preferred embodiment multiple cells, being interconnected by at least one flexible element, are deposited onto a single substrate. To secure sufficient flexibility of the energy source, the substrate used is preferably also made of a flexible material, e.g. DuPont Kapton® polyimide film or other polymer films. In case each cell is deposited on a separate substrate, also rigid materials may be used.

Preferably, at least one electrode of the energy source according to the invention is adapted for storage of active species of at least one of following elements: hydrogen (H), lithium (Li), beryllium (Be), magnesium (Mg), aluminium (Al), copper (Cu), silver (Ag), sodium (Na) and potassium (K), or any other suitable element which is assigned to group 1 or group 2 of the periodic table. So, the electrochemical energy source of the energy system according to the invention may be based on various intercalation mechanisms and is therefore suitable to form different kinds of (reserve-type) battery cells, e.g. Li-ion battery cells, NiMH battery cells, et cetera. In a preferred embodiment at least one electrode, more particularly the battery anode, comprises at least one of the following materials: C, Sn, Ge, Pb, Zn, Bi, Sb, Li, and, preferably doped, Si. A combination of these materials may also be used to form the electrode(s). Preferably, n-type or p-type doped Si is used as electrode, or a doped Si-related compound, like SiGe or SiGeC. Also other suitable materials may be applied as anode, preferably any other suitable element which is assigned to one of groups 12-16 of the periodic table, provided that the material of the battery electrode is adapted for intercalation and storing of the abovementioned reactive species. The aforementioned materials are in particularly suitable to be applied in lithium ion based battery cells. In case a hydrogen based battery cell is applied, the anode preferably comprises a hydride forming material, such as AB₅-type materials, in particular LaNi₅, and such as magnesium-based alloys, in particular MgₓTi₁₋ₓ. The cathode for a lithium ion based cell preferably comprises at least one metal-oxide based material, e.g. LiCoO₂, LiNiO₂, LiMnO₂ or a combination of these such as. e.g. Li(NiCoMn)O₂. In case of a hydrogen based energy source, the cathode preferably comprises Ni(OH)₂ and/or NiM(OH)₂, wherein M is formed by one or more elements selected from the group of e.g. Cd, Co, or Bi.

In a preferred embodiment at least one electrode of the first electrode and the second electrode is patterned at least partially. By patterning or structuring one, and preferably both, electrodes of the electrochemical energy source according to the invention, a three-dimensional surface area, and hence an increased surface area per footprint of the electrode(s), and an increased contact surface per volume between the at least one electrode and the electrolytic stack is obtained. This increase of the contact surface(s) leads to an improved rate capacity of the energy source, and hence to an increased performance of the energy source according to the invention. In this way the power density in the energy source may be maximized and thus optimized. Due to this increased cell performance a small-scale energy source according to the invention will be adapted for powering a small-scale electronic device in a satisfying manner. Moreover, due to this increased performance, the freedom of choice of (small-scale) electronic components to be powered by the electrochemical energy source according to the invention will be increased substantially. The nature, shape, and dimensioning of the pattern may be various, as will be elucidated below. It is preferred that at least one surface of at least one electrode is substantially regularly patterned, and more preferably that the applied pattern is provided with one or more cavities, in particular pillars, trenches, slits, or holes, which particular cavities can be applied in a relatively accurate manner. In this manner the increased performance of the electrochemical energy source can also be predetermined in a relatively accurate manner. In this context it is noted that a surface of the substrate onto which the stack is deposited may be either substantially flat or may be patterned (by curving the substrate and/or providing the substrate with trenches, holes and/or pillars) to facilitate generating a three-dimensional oriented cell.

The electrochemical energy source preferably comprises at least one barrier layer being deposited between the substrate and at least one electrode, which barrier layer is adapted to at least substantially preclude diffusion of active species of the cell into said substrate. In this manner the substrate and the electrochemical cell will be separated chemically, as a result of which the performance of the electrochemical cell can be maintained relatively long-lastingly. In case a lithium ion based cell is applied, the barrier layer is preferably made of at least one of the following materials: Ta, TaN, Ti, and TiN. It may be clear that also other suitable materials may be used to act as barrier layer.

In a preferred embodiment preferably a substrate is applied, which is ideally suitable to be subjected to a surface treatment to pattern the substrate, which may facilitate patterning of the electrode(s). The substrate is more preferably made of at least one of the following materials: C, Si, Sn, Ti, Ge, Al, Cu, Ta, and Pb. A combination of these materials may also be used to form the substrate(s). Preferably, n-type or p-type doped Si or Ge is used as substrate, or a doped Si-related and/or Ge-related compound, like SiGe or SiGeC. As mentioned afore, beside relatively rigid materials, also substantially flexible materials, such as e.g. foils like Kapton® foil, may be used for the manufacturing of the substrate. It may be clear that also other suitable materials may be used as a substrate material.

The invention also relates to an electronic device provided with at least one electrochemical energy source according to the invention, and at least one electronic component connected to said electrochemical energy source. The at least one electronic component is preferably at least partially embedded in the substrate of the electrochemical energy source. In this manner a System in Package (Sip) may be realized. In a SiP one or multiple electronic components and/or devices, such as integrated circuits (ICs), actuators, sensors, receivers, transmitters, et cetera, are embeddded at least partially in the substrate of the electrochemical energy source according to the invention. The electrochemical energy source according to the invention is ideally suitable to provide power to relatively small high power electronic applications, such as (bio)implantantables, hearing aids, autonomous network devices, and nerve and muscle stimulation devices, and moreover to flexible electronic devices, such as textile electronics, washable electronics, applications requiring pre-shaped batteries, e-paper and a host of portable electronic applications.

### BRIEF DESCRIPTION OF THE DRAWINGS

The invention is illustrated by way of the following non-limitative examples, wherein:

FIG. 1 shows a schematic cross section of an electrochemical energy source according to the prior art,

FIG. 2 shows a schematic cross section of a flexible electrochemical energy source according to the invention, and

FIG. 3 shows a schematic view of another electrochemical energy source according to the invention.

### DETAILED DESCRIPTION OF THE EMBODIMENTS

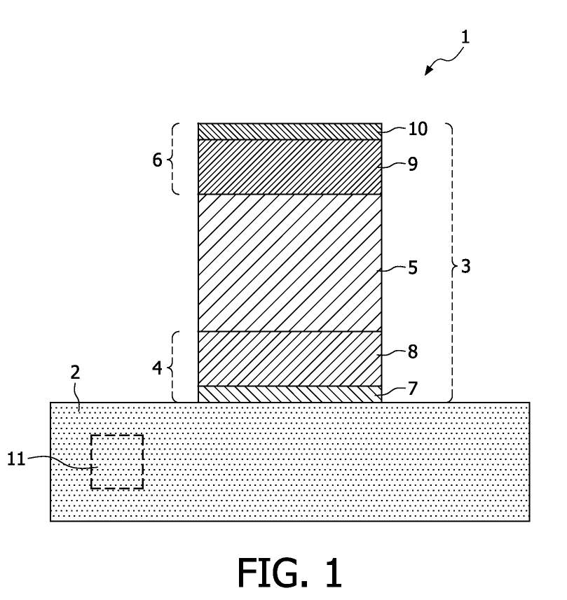

FIG. 1 shows a schematic cross section of an electrochemical energy source 1 according to the prior art. The known electrochemical energy source 1 comprises a substrate 2 on top of which an electrochemical cell 3 is deposited. The cell 3 comprises a first electrode 4, an electrolyte 5, and a second electrode 6. In this example, the first electrode 4 consists of a first current collector 7, and an cathode 8 deposited on top the first current collector 7, while the second electrode 6 consists of a anode 9, and a second current collector 10 deposited on top of the cathode 9. In this example, the substrate 2 is made from silicon in which one or more electronic components 11 may be embedded, wherein the current collectors 7, 10 are commonly electrically connected to the electronic component(s) 11. Optionally, a reverse stack could be applied wherein the first electrode comprises an anode, and the second electrode comprises a cathode.

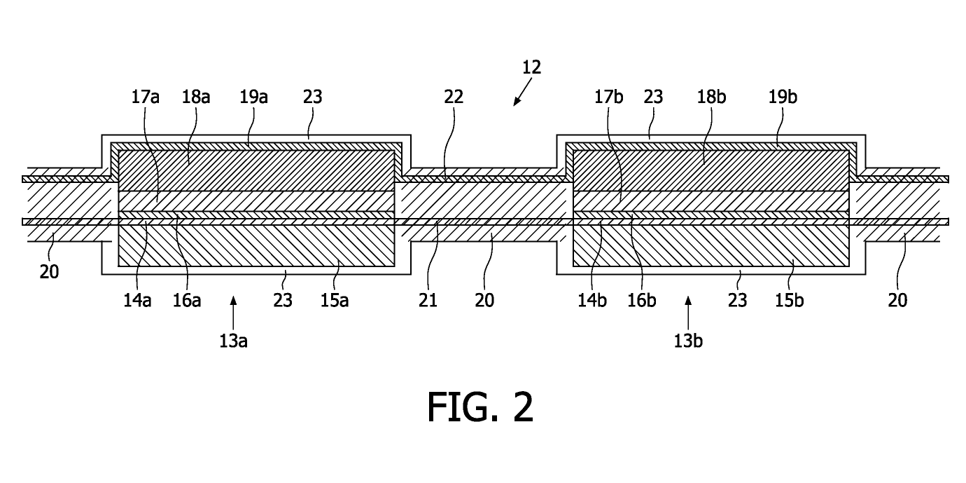

FIG. 2 shows a schematic cross section of an electrochemical energy source 12 according to the invention. The electrochemical energy source 12 comprises multiple lithium ion cells 13a, 13b, each cell comprising a stack of a first current collector 14a, 14b deposited onto a silicon substrate 15a, 15b, and an anode 16a, 16b deposited on top of the first current collector 14a, 14b, a solid-state electrolytic layer 17a, 17b deposited on top of the anode 16a, 16b, a cathode 18a, 18b deposited on top of the electrolytic layer 17a, 17b, and a second current collector 19a, 19b deposited on top of the cathode 18a, 18b. The first current collectors 14a, 14b also act as lithium ion barrier layer to preclude of active species (lithium ions) into the silicon substrate 15a, 15b. The cells 13a, 13b as such are relatively rigid. The cells 13a, 13b are mutually coupled by a flexible interconnecting element 20 at least partially made of rubber and/or polymer. An flexible anode conductor 21 and a flexible cathode conductor 22 are embedded in insulating parts of the interconnecting element 20. The conductors are preferably made of a conductive polymer, a conductive rubber, and/or a metal layer. It is also shown that the cells 13a, 13b as such are also covered with a flexible coating 23. Commonly the interconnecting element 20 and the flexible coating 23 are mutually integrated to provide a relatively stable flexible energy source 12. Since the electrochemical energy source 12 is in fact segmented into an array of substantially rigid cells 13a, 13b mutually coupled by means a flexible interconnecting element 20, the cells 13a, 13b are able to move and shift independently from each other, thus resulting in a stretchable and relatively flexible energy source which may e.g. be applied in flexible electronic devices.

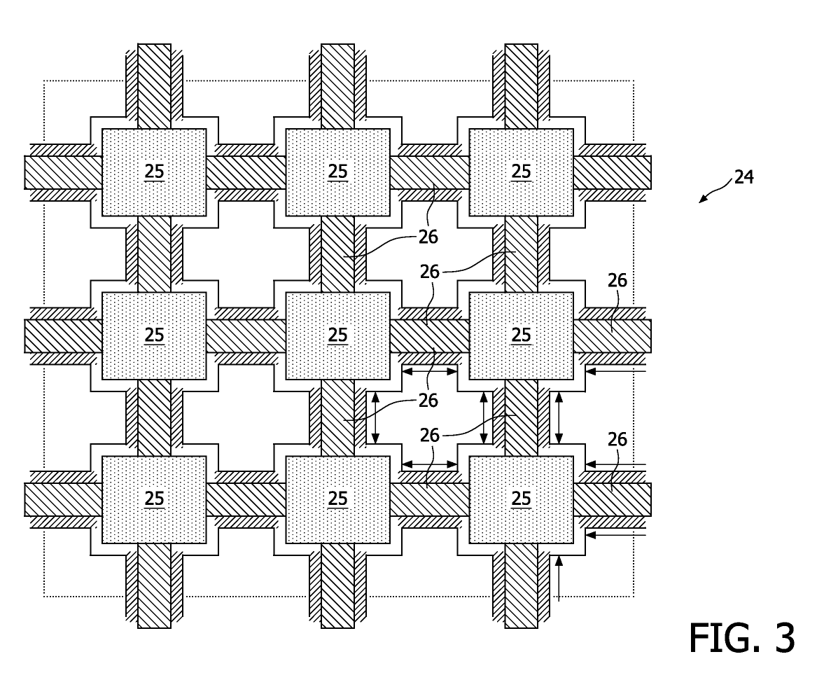

FIG. 3 shows a schematic view of another electrochemical energy source 24 according to the invention. The energy source 24 comprises multiple electrochemical cells 25 mutually coupled by means of flexible bridges 26, as a result of which the electrochemical energy source 24 will be provided flexible characteristics. Hence, the electrochemical energy source 24 will be stretchable in two directions (see arrows). The cells 25 may be constructed as shown in FIG. 2. The cells are preferably mutually connected electrically by means of conductive layers (not shown) being embedded in the flexible bridges 26. In this manner a relatively powerful and flexible energy source 24 can be provided in a relatively efficient and effective manner.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. The mere fact that certain measures are recited in mutually different dependent claims does not indicate that a combination of these measures cannot be used to advantage.

1. Electrochemical energy source, comprising:
multiple electrochemical cells, wherein each cell is deposited onto a substrate, each cell comprising:
a first electrode,
a second electrode, and
an electrolyte separating said first electrode and said second electrode;
wherein at least two cells are interconnected by means of at least one flexible element.

2. Electrochemical energy source according to claim 1, characterized in that the first electrode comprises an anode, and/or that the second electrode comprises a cathode.

3. Electrochemical energy source according to claim 2, characterized in that each cell is connected to at least one other cell by means of at least one flexible element.

4. Electrochemical energy source according to claim 1, characterized in that at least one cell is connected to multiple other cells by means of at least one flexible element.

5. Electrochemical energy source according to claim 1, characterized in that the at least one flexible element comprises at least one flexible conductor for connecting respective electrodes of adjacent cells.

6. Electrochemical energy source according to claim 4, characterized in that the at least one flexible element comprises multiple flexible conductors for connecting respective electrodes of adjacent cells.

7. Electrochemical energy source according to claim 4, characterized in that at least one flexible conductor comprises a conductive polymer or a conductive rubber.

8. Electrochemical energy source according to claim 1, characterized in that multiple cells, being interconnected by at least one flexible element, are deposited onto a single substrate.

9. Electrochemical energy source according to claim 2, characterized in that both the anode and the cathode are adapted for storage of active species of at least one of following elements: H, Li, Be, Mg, Cu, Ag, Na and K.

10. Electrochemical energy source according to claim 2, characterized in that at least one of the anode and the cathode is made of at least one of the following materials: C, Sn, Ge, Pb, Zn, Bi, Li, Sb, and, preferably doped, Si.

11. Electrochemical energy source according to claim 1, characterized in that at least one electrode is of at least one cell is provided with at least one patterned surface.

12. Electrochemical energy source according to claim 11, characterized in that the at least one patterned surface of the at least one electrode is provided with multiple cavities.

13. Electrochemical energy source according to claim 12, characterized in that at least a part of the cavities form pillars, trenches, slits, or holes.

14. Electrochemical energy source according to claim 1, characterized in that the first electrode and the second electrode each comprises a current collector.

15. Electrochemical energy source according to one claim 14, characterized in that the at least one current collector is made of at least one of the following materials: Al, Ni, Pt, Au, Ag, Cu, Ta, Ti, TaN, and TiN.

16. Electrochemical energy source according to claim 1, characterized in that the energy source further comprises at least one electron-conductive barrier layer being deposited between the substrate and at least one electrode, which barrier layer is adapted to at least substantially preclude diffusion of active species of the cell into said substrate.

17. Electrochemical energy source according to claim 16, characterized in that the at least one barrier layer is made of at least one of the following materials: Ta, TaN, Ti, and TiN.

18. Electrochemical energy source according to claim 1, characterized in that the substrate comprises at least one of the following materials: C, Si, Sn, Ti, Ge, Al, Cu, Ta, and Pb.

19. Electrochemical energy source according to claim 1, characterized in that the substrate is made of a flexible material.

20. Electronic device, comprising at least one electrochemical energy source according to claim 1, and at least electronic component connected to said electrochemical energy source.

21. Electronic device according to claim 20, characterized in that the at least one electronic component is at least partially embedded in the substrate of the electrochemical energy source.

22. Electronic device according to claim 20, characterized in that the at least one electronic component is chosen from the group consisting of: sensing means, pain relief stimulating means, communication means, and actuating means.

23. Electronic device according to claim 20, characterized in that the electronic device and the electrochemical energy source form a System in Package (SiP).
